(19) United States
(12) Patent Application Publication
(10) Pub. No.: US 2011/0083815 A1
(43) Pub. Date: Apr. 14, 2011

(54) RETRACTABLE RUBBER DOOR ASSEMBLY WITH ALIGNMENT PROTECTION STRUCTURES

(75) Inventors: Ray Kriner, Warren, OH (US); Joseph Aubel, Niles, OH (US)

(73) Assignee: Traichal Construction Co., Inc. dba Warren Door Co ., Niles, OH (US)

(21) Appl. No.: 12/896,193

(22) Filed: Oct. 1, 2010

Related U.S. Application Data
(60) Provisional application No. 61/278,829, filed on Oct. 13, 2009.

(51) Int. Cl. E06B 9/56; E06B 3/44; E06B 9/40

(52) U.S. Cl. 160/127

(57) ABSTRACT

A retractable rubber door assembly is stabilized through the use parallel guidestrips arranged within proximity to conventional windlock strips at a distance so that an extension of a curtain retainer structure will be positioned between the two strips.

### PRIORITY INFORMATION

The present invention claims priority to U.S. Provisional Application No. 61/278,829 filed on Oct. 13, 2009, making reference herein to same in its entirety.

### FIELD OF INVENTION

The present invention relates generally to large, removable, heavy duty doors having roll-type closure systems. In particular, the present invention is directed to structures and techniques for maintaining alignment of such doors under a wide variety of conditions, and avoiding many problems currently associated with such doors.

### BACKGROUND ART

Large door structures are well-known for aircraft hangers, mines, large vehicle enclosures, stock pile enclosures, animal shelters, industrial enclosures, and other large-scale industrial applications. One conventional approach to large doors or closures has been the use of a flexible curtain for closing the doorway or opening, and a curtain winding mechanism for lower and raising the curtain door. Such closures or doors are very advantageous in that the flexible material of the door allows catastrophic damage to be avoiding under conditions of impact (from collisions), high winds, earth quakes, and the like.

One advantage of doors or closures formed by flexible material such as rubber, is that they are relatively light. As a result, they can be raised, lowered or otherwise transported with relatively simple mechanical means, through the use of low-power motivating mechanisms. In many applications, a simple spring-loaded counter-balanced, wind-up drum is sufficient to provide both the retrieval and deployment functions for this type of closure system. Because the closure material is stored on the drum, very little additional space is necessary in comparison with rigid doors or closure structures which must be accommodated with extra storage space when the closure is stored when not deployed.

Various examples of flexible or curtain door applications, arrangements and techniques are disclosed in a number of U.S. patents, such as: U.S. Pat. No. 4,478,268 to Palmer; U.S. Pat. No. 3,430,677 to Pierce; and, U.S. Pat. No. 4,601,320 to Taylor. All of these are incorporated by reference as examples of the conventional technology.

One major advantage found with these arrangements is that catastrophic damage can be minimized due to the flexibility of the closure material. In some cases, the flexible curtain can be withdrawn (onto its roll drum) even under pressure differentials, which tend to force the rubber curtain closure against its frame. This type of door is especially useful in withstanding high winds, precipitation and the like.

Further, depending upon the arrangement, even after a catastrophic event, the flexible, curtain door can be reinstalled onto its drum and into its tracks (defined by the door frame and retaining piece), so as to resume functionality. Depending upon the size of the door and the configuration of the tracks in which the door rides, this can be a fairly simple operation, or it can be a very complex and time-consuming operation.

Catastrophic events are not the only difficulties facing this type of flexible closure system. Depending upon the weight of the flexible overhead closure, wind conditions, and the capabilities of the mechanical reeling system, misalignment of the flexible curtain can occur. This most often happens due to extensive flexing, “walking”, shifting, bunching, buckling (hour glass effect), and the like. Such curtain distortion or shifting can occur either during deployment, or when rewinding. Any number of mechanical and environmental factors can lead to the shifting of the flexible curtain that will often result in wear and other degradation.

Also, substantial rewinding and deployment can degrade the material of the flexible curtain, especially if misalignment occurs due to “walking”, shifting wind pressure, or the like. If a heavy deployment and rewind cycle is employed, the fabric can substantially deteriorate, reducing the life and effectiveness of the flexible closure. Replacement, especially of a large high-grade rubber curtain, can be quite expensive.

While catastrophic events are relatively rare, deterioration due to normal use, and exacerbated deterioration due to even slight misalignment during that use remain major problems that cannot be avoided by the most stringent safety measures. Accordingly, the art of flexible overhead closures admits to a great deal of improvement, especially with respect to protecting the material of the flexible closure/door from deterioration due to normal use, and from misalignment.

### SUMMARY OF INVENTION

It is a primary goal of the present invention to minimize or eliminate flexible overhead closure/door deterioration caused by misalignment, normal deployment, or mischance.

It is another object of the present invention to prevent shifting of a flexible overhead door in the deployed position.

It is a further object of the present invention to prevent bunching, buckling or “hour glassing” of a flexible overhead door during retrieval or deployment.

It is an additional object of the present invention to configure and operate an overhead flexible door in a manner to decrease wear and strain on specific parts of the door, such as lubricating strips and reinforcing areas.

It is yet a further object of the present invention to provide techniques for minimizing total wear on a flexible overhead door.

It is again an additional object of the present invention to provide a technique to better facilitate easy handling of an overhead flexible door.

It is yet a further object of the present invention to provide a structure to better lubricate wear-exposed portions of a flexible overhead door.

It is again a further object of the present invention to provide a technique to maintain flexible overhead door in proper alignment throughout a full range of opening and closing cycles.

These and other goals and objects of the present invention are achieved by a flexible, retractable door system including a flexible door and a fixed door frame. The door has a front surface and a rear surface with a windlock structure. The frame has a retainer extending over the windlock. The system also has a rubber guidestrip running along at least one length of the flexible door in a position so that an end of the curtain retainer is positioned between the guidestrip and the windlock.

### BRIEF DESCRIPTION OF DRAWINGS

FIG. 1 is a top sectional view depicting an overhead door in a deployed position.

FIG. 2 is a detailed view of FIG. 1, emphasizing only the wind lock and the guide strip.

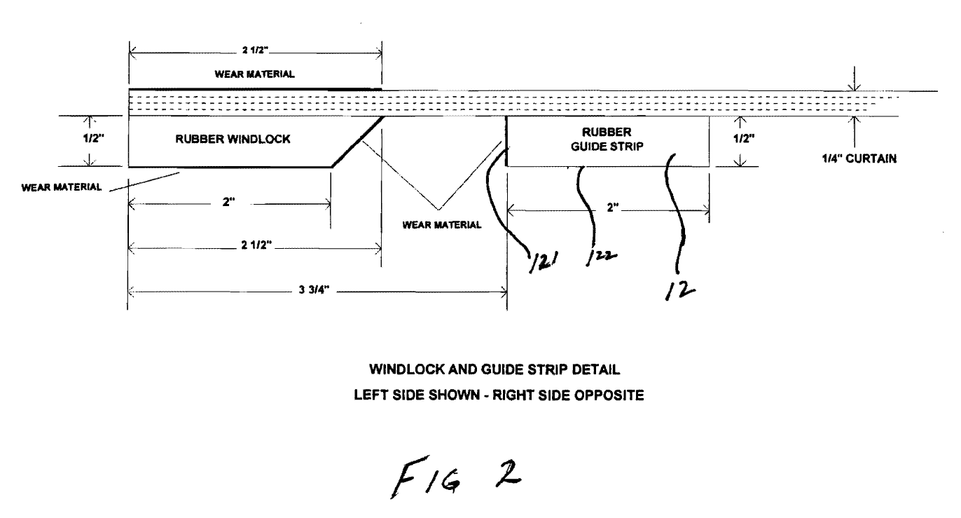

FIG. 3 is a rear view of the flexible rollup door in the deployed position (without the frame work).

FIG. 4 is a top sectional view of the flexible overhead door depicting details of a second embodiment of the present invention.

FIG. 5 is a perspective view of alignment structures at the bottom of the flexible door, depicting a further embodiment of the present invention.

### DETAILED DESCRIPTION OF PREFERRED EMBODIMENTS

The system of the present invention, as depicted in the drawings includes a series of inventive structures that working together, and to a lesser extent individually maintain the alignment of a flexible, retractable overhead closure/door in its track system. Such maintenance of alignment is crucial since flexible overhead doors tend to become misaligned, either as part of the deployment/retrieval operation, or as a result of environmental conditions. Misalignment most commonly leads to increased wear on the door material and its bearing/lubricating elements, and ultimately to the failure of both the function of the door and its overall structure.

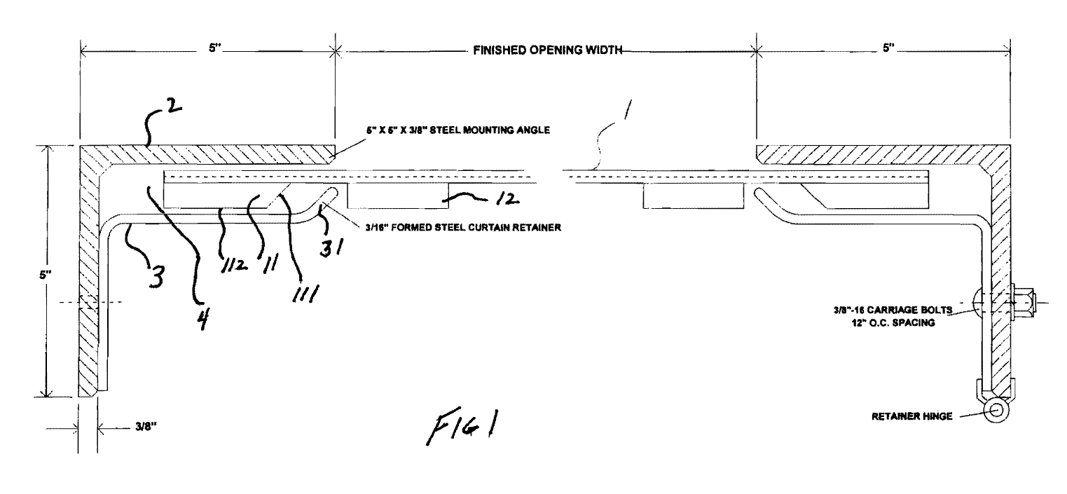

The structure of the conventional flexible overhead door 1, as depicted in the conventional portion of FIG. 1 and Appendix A, is already well-known, and needs no further elaboration for purposes of understanding the various embodiments of the present invention. In particular, the flexible door 1 has windlocks or wind guards 11 that fit into channels 4 formed in the door frame 2 (and curtain retainer 3) encompassing the sides of the door 1 when in the deployed position. There is also a bottom bar 6 to help maintain the shape of the door, as well at the integrity of the overall structure once deployed.

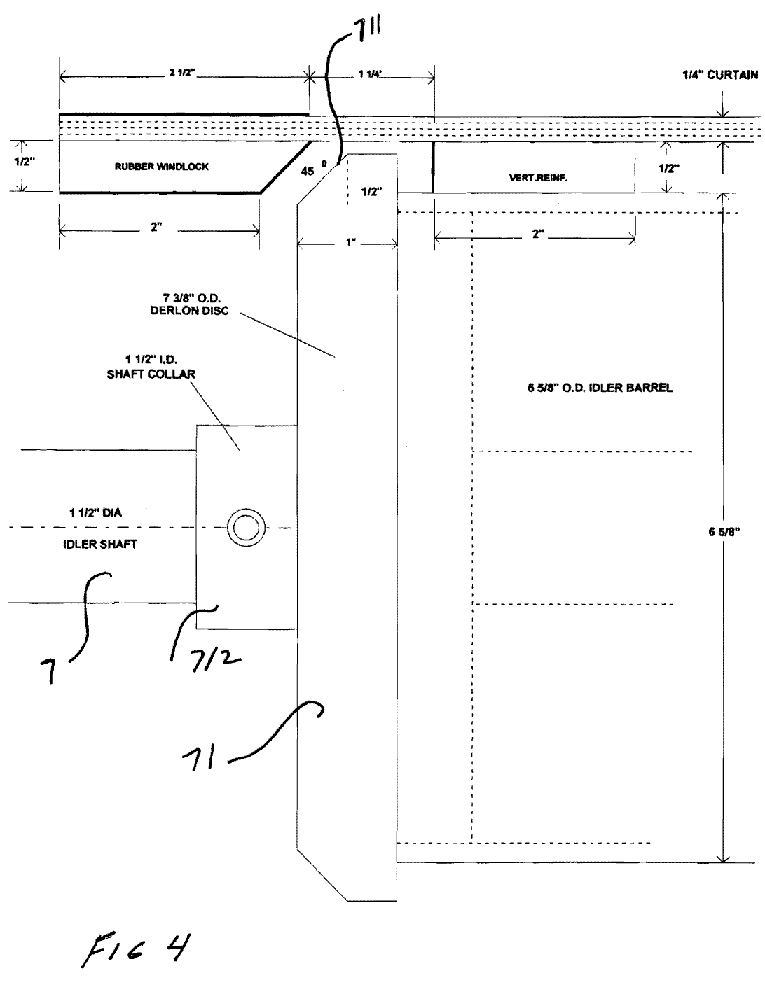

The door is open and closed by a drum reel (partially depicted in FIG. 4), which is assisted by an idler barrel (also depicted in FIG. 4). Examples of this conventional arrangement can be found in the previously cited conventional art and in the advertisement included as Appendix A, attached to this application.

The present invention operates as part of a flexible, overhead closure or door 1 within a framed opening which must be covered or contained by a closure. It is necessary that the opening be framed with some sort of structure in order to receive the closure, and to mount the storage drum and motivating system, as well as providing support for the bulk of the door. The frame work around the opening should accommodate a channel structure to hold at least a portion of flexible door 1. As depicted in FIG. 1, a front angle piece 2 is used in conjunction with a curtain retainer 3 to serve as a channel 4 for wind guard or wind lock 11, which is formed as part of flexible door 1.

Preferably, the flexible door 1 is constructed of a two ply, nominal ¼ inch-thick rubber sheet. Preferably, the sheet will have a tensile strength of 160 lb./2000 lb. per square inch rating, and will be of R.M.A. grade II. The temperature ranges for normal flexibility are preferably from −10° F. through 220° F. The wind locks 11 are preferably made of ½ inch R.M.A. grade II material. The rubber wind locks 11 are preferably bonded to rubber door 1 in any one of a number of conventional techniques.

The guide structure, including frame bracket 2 and curtain retainer 3 are constructed together so as to form a channel 4 to contain wind lock 11, in the deployed position, and as the rubber door 1 is deployed or retrieved on its storage drum (FIG. 4). Preferably, both of these pieces are made of heavy-duty, preformed structural steel. Preferably, the retainer 3 is 11 gauge. However, other sizes can be used depending upon the size of door 1 and wind lock 11.

The guide created by channel 4, retainer 3, and frame 2 will be loose enough to allow free movement of door 1 is sufficiently tight to create sufficient tension so that the door will be able to operate in wind pressures up to 20 lbs. per square foot (generally equivalent to a wind speed of 88 miles per hour) without disengaging from the channels 4. This arrangement will also allow the wind lock to disengage from the channel or guide system in pressures greater than 20 lbs. per square foot (thereby avoiding tearing of the door material under extreme stress). The curtain retainer 3 can be attached to the rest of the frame 2 in such a way that it is easily removable so that door 1 can be reattached if wind lock 11 has been forced loose from channel 4.

The curtain retainer 3 has an angled extension 31, which extends relatively close to curtain door 1. This angled extension is arranged substantially parallel to a beveled surface 111 of wind lock 11. This allows a tighter fit within guide channel 4 for the wind lock 11. This angled extension and matching surface 111 on wind lock 11 provide increased holding capability so that curtain door 1 is not as easily torn loose or otherwise dislocated under environment stress or collision.

Because there will be high pressure contact between pieces such as wind lock beveled surface 111 and different parts of curtain retainer 3, a lubricating and wear agency is necessary. Consequently, surfaces 112 and 111 of wind lock 11 are covered with a nylon fabric, and attached thereto by conventional techniques. The fabric currently in use is DuPont catalog number 728. However, despite these expediences, misalignment and ultimately dislocation frequently occur with conventional door systems of this type.

In order to prevent misalignment and resulting dislocation in conventional systems, an additional expedient is needed to help keep the wind lock 11. in channel 4, under all circumstances. A first embodiment of the present invention addresses potential misalignment due to “walking”, horizontal shifting, buckling, or sagging (due to gravity and material deterioration) of curtain closure/door 1. This is accomplished by a rubber guide strip 12. This guide strip is located approximately 1¼ inches from the edge of beveled surface 111 of wind lock 11. This arrangement prevents “walking” or other types of shifting that can force the wind lock 11 from channel 4. Side surface 121 of guide strip 12 is provided with the nylon fabric lubricating medium as is done with the surfaces 111, 112 of wind lock 11. This allows interface with retainer 3 without the danger of binding between retainer 3 and guide strip 12. The nylon fabric also limits material deterioration of guide strip 12 and wind lock 11.

The width of wind lock 11 is depicted as being 2½ inches, including approximately ½ inch of beveled surface. Since wind lock 11 extends the entirety of the length of door 1, there is a substantial decrease in the flexibility of the overall door structure. This condition is also exacerbated by the addition of two rubber guide strips 12 on each door 1. The lack of flexibility is enhanced by the nylon lubricating fabric which covers the back surfaces 112 of each of the wind locks 11. The nylon fabric runs the entire length of the wind locks and is bonded thereto, thereby preventing flexibility since there is only a limited amount of stretching provided by the nylon fabric, which is between 1/32 inch and 1/16 inch thick. To address this problem, siping 5 is provided in the nylon covering surface 112, every three inches along the length of wind lock 11. This siping 5 is constituted by cuts in both the nylon fabric and the wind lock 11. Each cut is semi-circular, approximately ⅛ inch wide and ⅛ inch deep. Since the front surfaces 122 of the guides are not covered with the nylon lubricating/wear fabric, siping to enhance flexibility of these elements is not required.

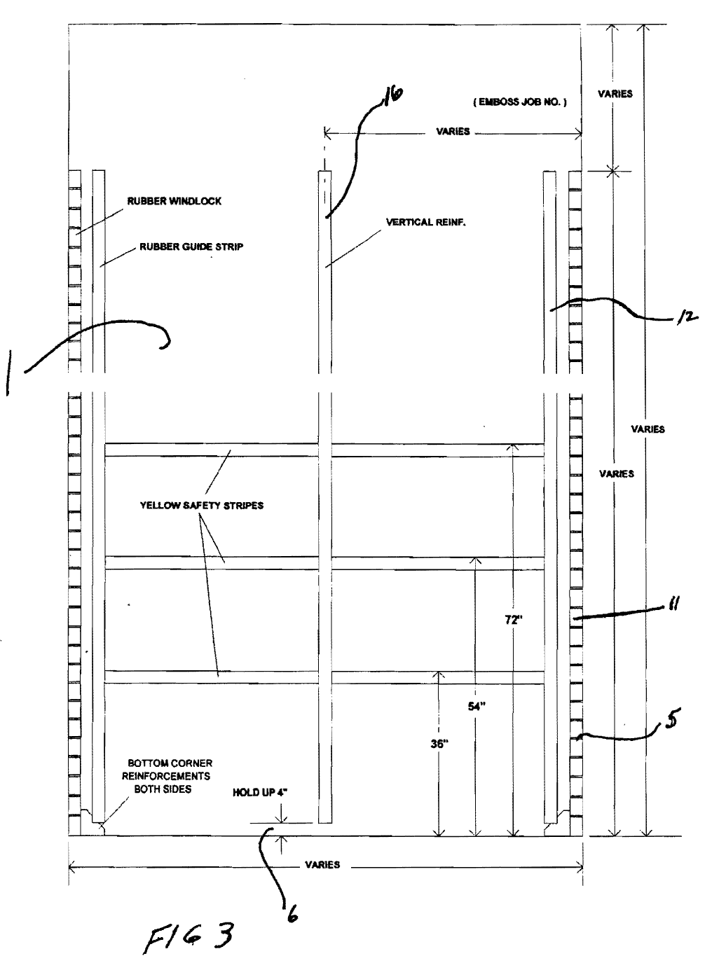

It should be understood that the sipping 5 as depicted in FIG. 3 will be arranged periodically (for example every 3 inches) along the entire fabric-covered length of each wind lock 11. The siping 5 will cut the nylon fabric as well as the underlying rubber strip. It should also be understood that any other fabric-covered surface that extends an appreciable extend along the length of door 1 can also be provided with sipings to ensure the proper level of flexibility. Besides flexibility for the overall door, the use of siping 5 also relieves tension on the fabric which might otherwise deteriorate the bond between the fabric and the underlying rubber, or contribute to the failure of the fabric itself.

If other structures such as vertical reinforcing strip 16 (as depicted in FIG. 3) is bonded with the nylon lubricating/wear fabric, then siping of the strip 16 and its nylon cover would be appropriate. However, siping of the nylon fabric on surface 121 of the rubber guide strip 12 is not necessary since the overall flexibility of the door is not compromised by the fabric on this surface. Nor is the fabric on surface 121. compromised by the retracting and deployment of the door 1.

The use of an idler bar or shaft is a common feature in the conventional art of retractable flexible door operation. Conventional idler bar 7 is disclosed clearly in Appendix A, and FIG. 4. An additional embodiment of the present invention is the provision of a Durlon® disc 71 on the idler shaft 7. The Durlon® disc is approximately 7⅜ inches in diameter, and approximately 1 inch thick, as depicted in FIG. 4. Beveled surface 711 of Durlon® disc 71 is formed at approximately a 45° angle, and parallels surface 111 of wind guard 11. The presence of the Durlon® disc serves to further stabilize the flexible door 1 close to the reel barrel, which is used to wind and hold the door in the open position. As seen in the top view of FIG. 4, Durlon® disc 71 is roughly in the same position as the extension 31 of curtain retainer 3. However, the Durlon® disc is mounted above the area occupied by curtain retainer 3, and serves to further stabilize door 1 by limiting shifting or walking closer to the reel drum depicted in Appendix A. While a 1″×7″ disc, as depicted in FIG. 4 is appropriate for one existing design for a retractable flexible door 1, these dimensions can vary depending upon the size and other characteristics of flexible door 1.

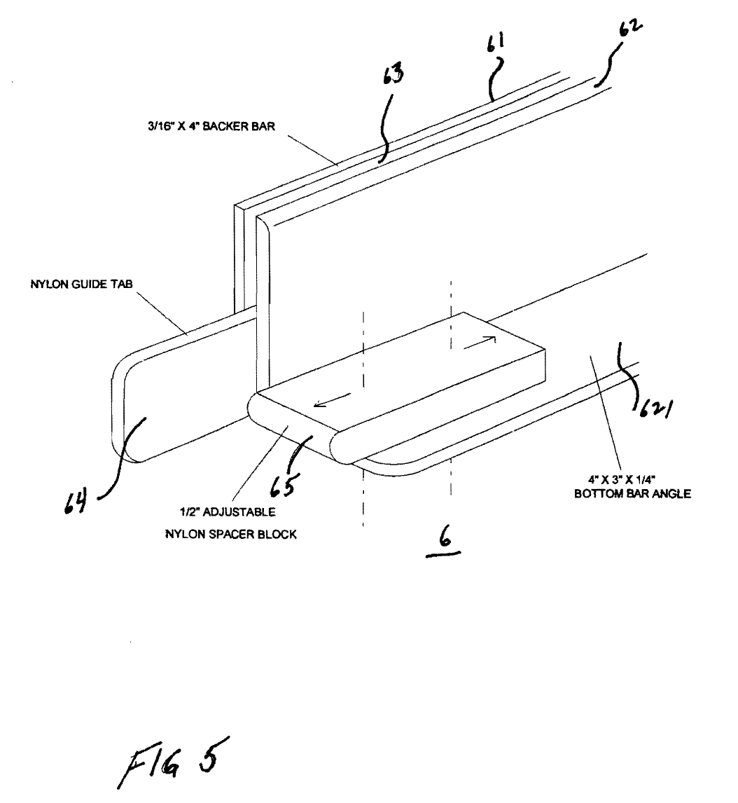

Another embodiment of the present invention adds further stabilization at the bottom bar 6. Conventional bottom bar structures are depicted generally in Appendix A. The present invention is depicted specifically in FIG. 5. Preferably, the bottom bar 6 is sized and configured for the size of the door 1. Curtain door 1 fits into the space 63 between opposing steel pieces 61. and 62. Steel piece 62 has a 90° angled footplate 621. A nylon spacer bar 64 also fits in the space 63 and extends to the side of curtain door 1. Nylon guide tab 64 extends into guide space 4 to help maintain the overall door structure within the guide system. However, with just nylon tab 64, a great deal of shifting is still permitted with respect to the door and the guide structure (constituted by framework 2, curtain retainer 3, and channel 4). In order to create a much tighter fit between bottom bar 6 and the frame work around door 1, adjustable nylon block 65 is provided as part of the further embodiment of the present invention. This nylon block 65 can be adjusted along the top of iron angle 621 by any number of structures and techniques already well-known in the mechanical arts. The use of nylon spacer block 65 provides both a tighter fit for flexible door 1 and serves as a bearing component.

While a number of embodiments have been described by way of example, the present invention is not limited thereto. Rather, the present invention should be construed to include any and all embodiments, variations, permutations, adaptations, and derivations that would occur to one skilled in this art with the teachings of the present invention. Accordingly, the present invention should be limited only by the following claims.

1. A flexible, retractable door system including a flexible door and a fixed door frame, said door having a front surface and rear surface with a windlock structure arranged on said rear surface, said frame having a retainer extending over said windlock, said flexible retractable door system further comprising:
(a) at least one guidestrip running along a length of said rear surface of said flexible door and positioned so that an end of said curtain retainer is positioned between said guidestrip and said windlock.

2. The flexible, retractable door system of claim 1, wherein said windlock comprises two substantially parallel strips, each extending along a length of said flexible retractable door, and two said guidestrips extending parallel to said windlock strips.

3. The flexible, retractable door system of claim 2, wherein said two substantially parallel strips of said windlock and said two guidestrips extend over substantially the entire length of said flexible door.

4. The flexible, retractable door system of claim 3, further comprising a flexible fabric arranged over at least one surface of said windlock strips and said guidestrips.

5. The flexible, retractable door system of claim 4, wherein said windlock strips comprise a plurality of lateral sipings cut into said surface of said windlock strip at intervals.

6. The flexible, retractable door system of claim 5, wherein said siping comprises a plurality of notches cut into both said flexible fabric and said rubber strip in a semi-circular shape, approximately ⅛″ wide, ⅛″ deep and at intervals of approximately 3″ along the length of said windlock strip.

7. The flexible, retractable door system of claim 6, wherein said siping is formed on said guidestrips.

8. The flexible, retractable door system of claim 4, wherein said flexible fabric comprises nylon having a thickness between substantially 1/32″ thick and 1/16″ thick.

9. The flexible, retractable door system of claim 4, wherein said flexible door is approximately ¼″ thick, said windlock strip is approximately ½″ thick and 2½″ wide, said guidestrip is ½″ thick and 2″ wide, and a space of 1¼″ separates said windlock and said guidestrip.

10. The flexible, retractable door system of claim 9, wherein said windlock strip has a beveled surface covered with said flexible fabric facing said guidestrip.

11. The flexible, retractable door system of claim 10, further comprising at least one vertical reinforcing strip located between said two guidestrips.

12. The flexible, retractable door system of claim 1, further comprising: a bottom reinforcing structure arranged to hold the bottom edge of said flexible roll-up door in a rigid configuration.

13. The flexible, retractable door system of claim 10, wherein said bottom reinforcing structure comprises an L-shaped angle piece positioned to rest on a substrate supporting said door frame.

14. The flexible, retractable door system of claim 13, further comprising at least a first lateral extension extending beyond each said side of said flexible roll-up door.

15. The flexible, retractable door system of claim 14, further comprising a second lateral extension extending beyond each side of said flexible roll-up door.

16. The flexible, retractable door system of claim 16, wherein said first and second lateral extensions comprise nylon, rectangular structures, and said first lateral extension is positioned at 90° to said second lateral extension.

17. The flexible, retractable door system of claim 16, wherein said second lateral extension is arranged on each side of said L-angle piece.

18. The flexible, retractable door system of claim 1, further comprising a motivating system for rolling up and deploying said flexible, retractable door, wherein said motivating system comprises a Durlon® roller arranged between at least one said windlock strip and at least one said guidestrip.

19. The flexible, retractable door system of claim 18, wherein said Durlon® disk comprises a beveled surface facing said beveled surface on said windlock strip and being parallel thereto.
